(19) United States
(12) Patent Application Publication
(10) Pub. No.: US 2008/0172139 A1
(43) Pub. Date: Jul. 17, 2008

(54) System and method for enhancing perceptual quality of low bit rate compressed audio data

(76) Inventors: Russell Tillitt, San Francisco, CA (US); Darius Mostowfi, San Carlos, CA (US); Richard Powell, Mountain View, CA (US); S. Wayne Jackson, Santa Cruz, CA (US); Mark Deggeller, San Mateo, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/654,734

(22) Filed: Jan. 17, 2007

(51) Int. Cl. G06F 17/00

(52) U.S. Cl. 700/94

(57) ABSTRACT

A system and method for converting an audio data is described. The method includes separating the audio data into a first set of data and a second set of data. The method further includes converting the first set of data into a track of the audio data. The method also includes converting the second set of data into an at least one reference to a stored sound. The method includes mapping the at least one reference to the stored sound to an at least one position in the track where the stored sound is to be played when the track is played.

### BACKGROUND

1. Field of the Invention

This invention relates generally to the field of data processing systems. More particularly, the invention relates to a system and method for enhancing perceptual quality of low bit rate compressed audio data.

2. Description of the Related Art

Portable electronic devices have become an integral part people's lives. For example, many persons carry personal digital assistants (PDA's), portable media players, digital cameras, cellular telephones, wireless devices, and/or an electronic device with multiple functions (e.g., a PDA with cell phone abilities). Also with the rise in popularity of portable electronic devices, device users want the ability to play audio files or streaming audio on the device.

Portable electronic devices such as mp3 players and higher powered PDA's allow a user to play audio in formats such as mp3, advanced audio coder (AAC), AAC-plus, Windows® media audio (WMA), adaptive transform acoustic coding (ATRAC), ATRAC3, and ATRAC3Plus. Many electronic devices, though, have processing, bandwidth, memory, or power consumption limitations that make playing, receiving, and/or storing audio in such formats difficult or even impossible. For example, many cell phones are still unable to play high bit rate ringtones.

As a result, audio is converted into a low bit rate format in order for many devices with processing/storage/bandwidth limitations to be able to play the audio. One problem with the play of low bit rate audio is that the quality of the audio is significantly diminished and perceived as substandard by users of the device.

Therefore, what is needed is a system and method for enhancing perceptual quality of low bit rate compressed audio data.

### SUMMARY

A system and method for converting an audio data is described. The method includes separating the audio data into a first set of data and a second set of data. The method further includes converting the first set of data into a track of the audio data. The method also includes converting the second set of data into an at least one reference to a stored sound. The method includes mapping the at least one reference to the stored sound to an at least one position in the track where the stored sound is to be played when the track is played.

### BRIEF DESCRIPTION OF THE DRAWINGS

A better understanding of the present invention can be obtained from the following detailed description in conjunction with the following drawings, in which:

FIG. 1 illustrates a file conversion system.

FIG. 2 illustrates a portion of the file conversion system of FIG. 1 for filtering and converting the input file into frequency content.

FIG. 3 illustrates another portion of the file conversion system of FIG. 1 for reducing the frequency content of FIG. 2.

FIG. 4 illustrates a portion of the file conversion system of FIG. 1 for converting the reduced frequency content of FIG. 3 into time content and a map.

FIG. 5 illustrates a portion of the file conversion system of FIG. 1 for converting the time content and map of FIG. 4 into a track of sound bank references of the output file illustrated in FIG. 1.

FIG. 6 illustrates a portion of the file conversion system of FIG. 1 for converting the time content and map of FIG. 4 into a track of sound samples of the output file illustrated in FIG. 1.

FIG. 7 illustrates a portion of the file conversion system of FIG. 1 for encoding filtered content of FIG. 2 into a playable track.

FIG. 8 illustrates a file conversion service for communicating with a device including the file conversion system of FIG. 1.

FIG. 9 illustrates the device of FIG. 8 for playing the output file of FIG. 1.

FIG. 10 Illustrates an example output file of FIG. 1.

FIG. 11 illustrates a flow diagram for converting an input file into an output file by the file conversion system of FIG. 1.

FIG. 12 illustrates an example computer system for implementing embodiments of the file conversion system of FIG. 1.

### DETAILED DESCRIPTION OF PREFERRED EMBODIMENTS

The following description describes a system and method for converting an audio into a format of a lower bit rate. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

### File Conversion System

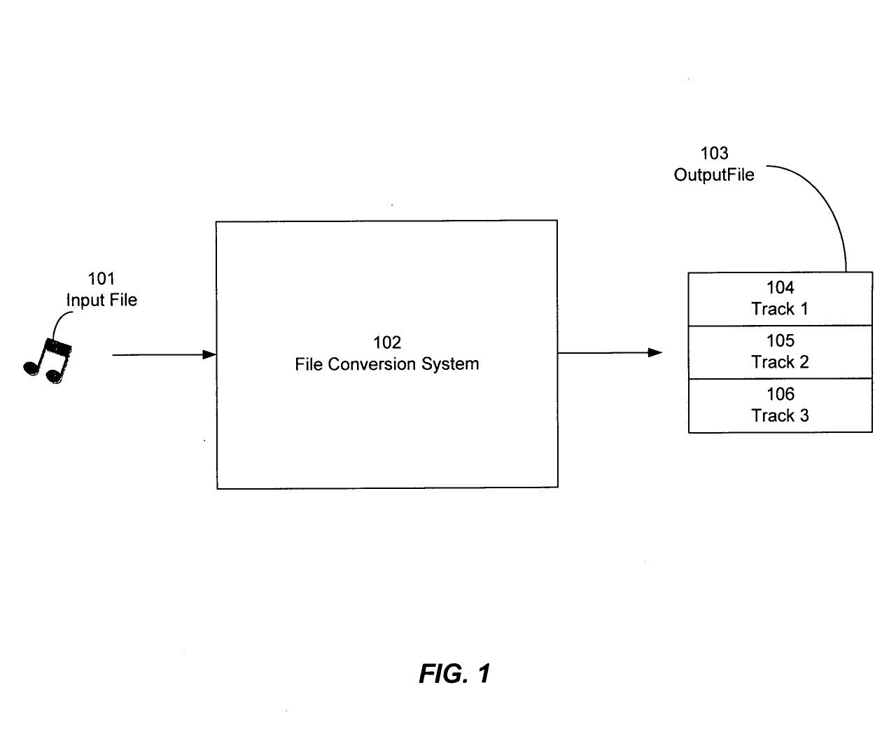

FIG. 1 illustrates a file conversion system 102 of converting an input file 101 into an output file 103. In one embodiment of the present invention, the output file 103 includes a track 1 104, track 2 105, and a track 3 106 and the input and output files 101, 103 are audio. The input file 101 is a larger size and/or higher bit rate than the output file 103.

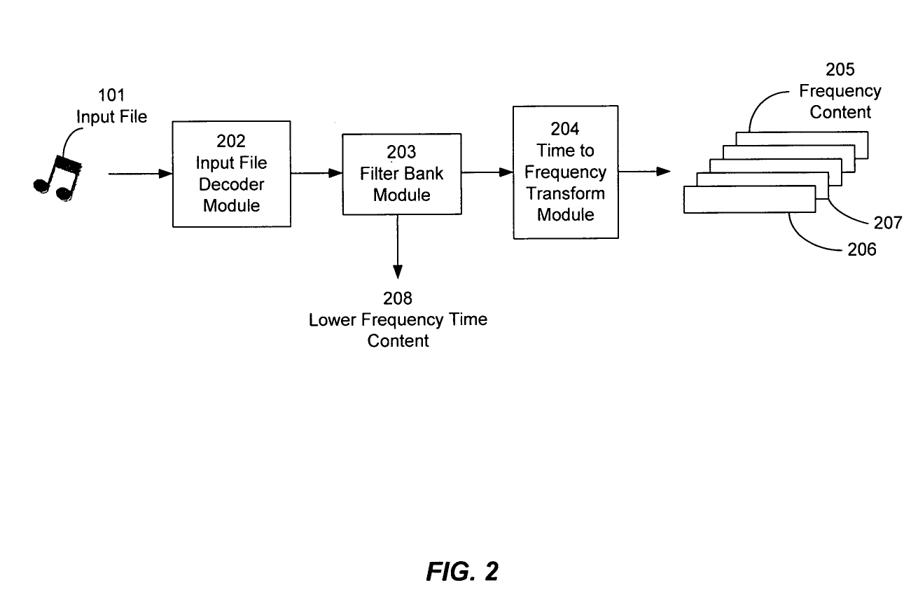

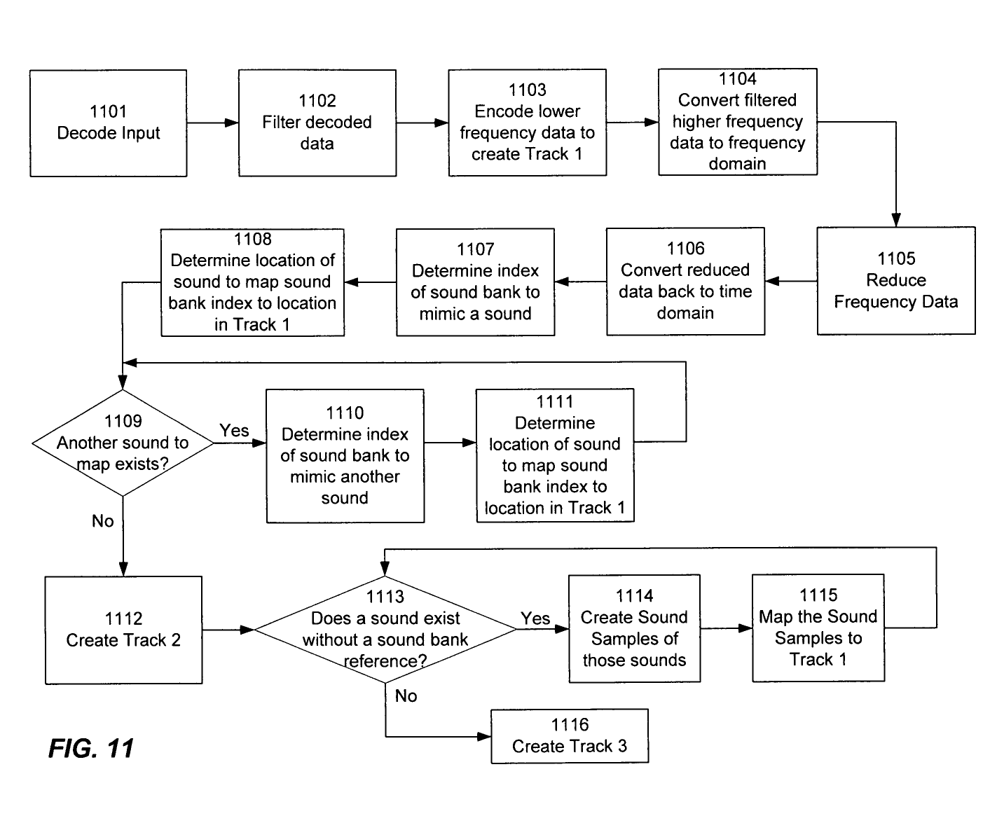

FIGS. 2-7 illustrates different portions of the file conversion system 102. FIG. 11 illustrates a flow diagram of an example of a method for converting an input file 101 into an output file 103. Referring to FIG. 2 and FIG. 11, the input file decoder module 202 of the file conversion system 102 receives and decodes the input file 101 into an editable format (e.g., RAW format) (1101 of FIG. 11). The decoder module 202 is able to decode multiple different formats for encoding audio. For example, the decoder module 202 receives an AAC, MP3, or WMA file and decodes the file into a RAW or other format that is easily editable.

Once the decoder module 202 finishes decoding the input file, the filter bank module 203 of FIG. 2 filters the decoded audio in 1102 of FIG. 11. In one embodiment, the filter bank module 203 filters the decoded audio into lower frequency time content 208 and higher frequency time content. Lower frequency time content 208 is low frequency audio content of the decoded audio where the content is still in time domain (not frequency domain). In one embodiment, the filter bank module 203 includes a low pass filter (LPF) and a high pass filter (HPF) to create the lower frequency time content 208 and the higher frequency time content. The filter bank module 203 may, in lieu or in addition, include more extravagant filters for filtering the decoded audio.

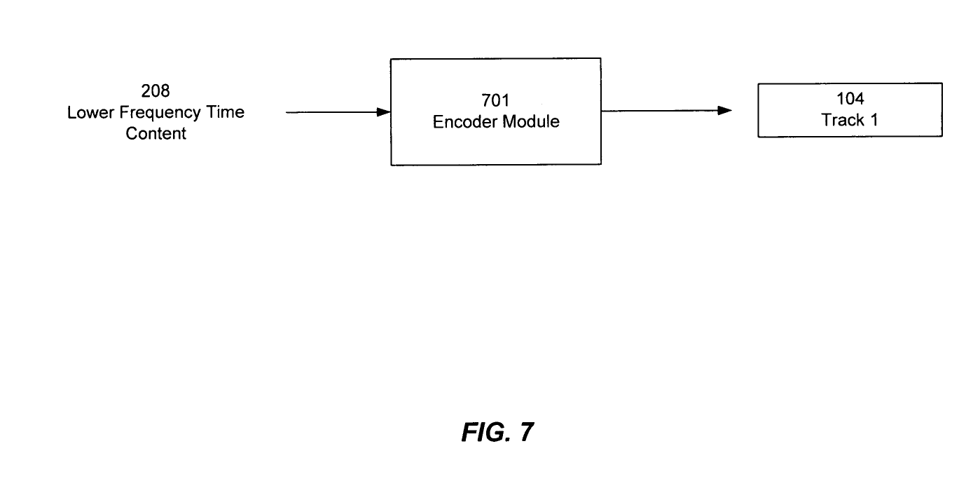

Referring back to FIG. 11 and also to FIG. 7, encoder module 701 encodes the lower frequency content 208 into track 1 104 of the output file 103 (FIG. 1). Track 1 is a specific audio file type, such as AAC or MP3. Therefore, in one embodiment of the present invention, track 1 104 of the output file 103 is playable by itself. If the track 1 104 is played exclusively, it may sound like a muffled and muddied version of the input file 101 because the high frequency content of the input file 101 has been removed.

Referring back to FIG. 2, the time to frequency transform module 204 converts the higher frequency time content into frequency content 205. In one embodiment, time content is separated into overlapping blocks of time content. The overlapping parts of the time content are then tapered through multiplication with a windowing function (e.g., Hann Window). Each resulting block is then converted into the frequency domain to create frequency content 205, which includes blocks 206, 207 which include the frequency data for a specific portion of the time of the audio. A lapped transform, such as but not limited to STFT, DCT, MDCT, and DWT, is used to create the frequency content 205. Additionally, a time indexed frequency content vector is indexed to the blocks of frequency content in order to recreate the original input file 101 if necessary.

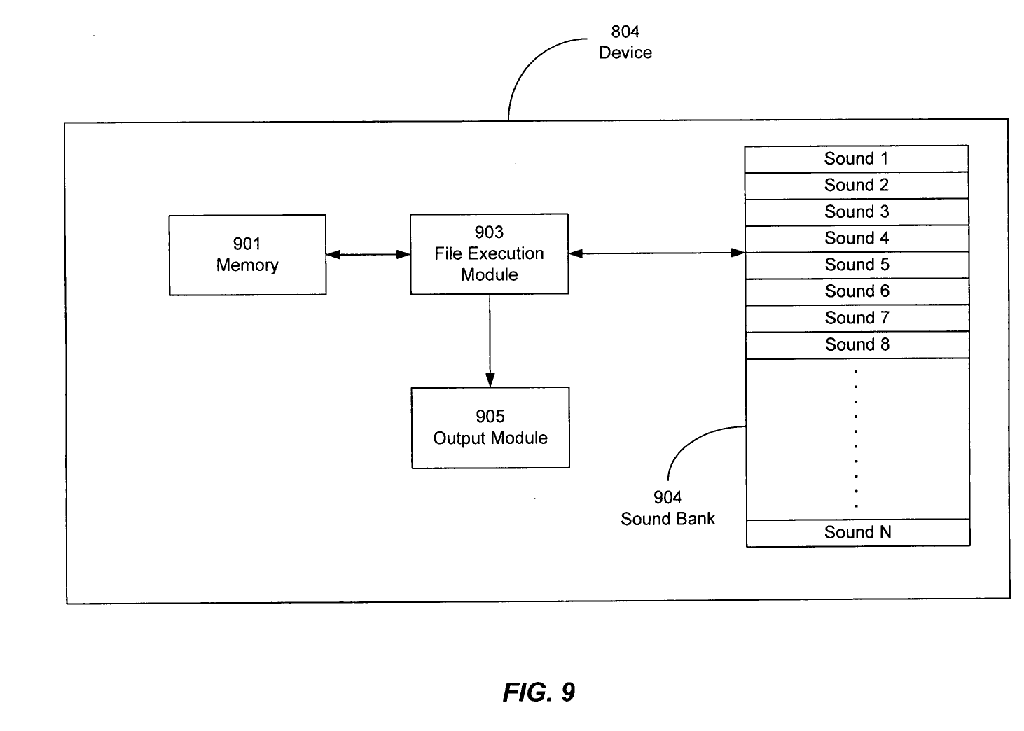

In one embodiment, a module of the file conversion system 102 determines the relative gain for each block of frequency content 205. The relative gain for each block is then stored by the module. The gain is later used by the device 804 to determine the volume level for playback of sound bank references and/or sound samples in relation t the volume of playback of Track 1 104 (stored sounds and/or created sounds on the device 804 in FIG. 9). Once the gain for each of the blocks is stored, the module normalizes the blocks of frequency content 205.

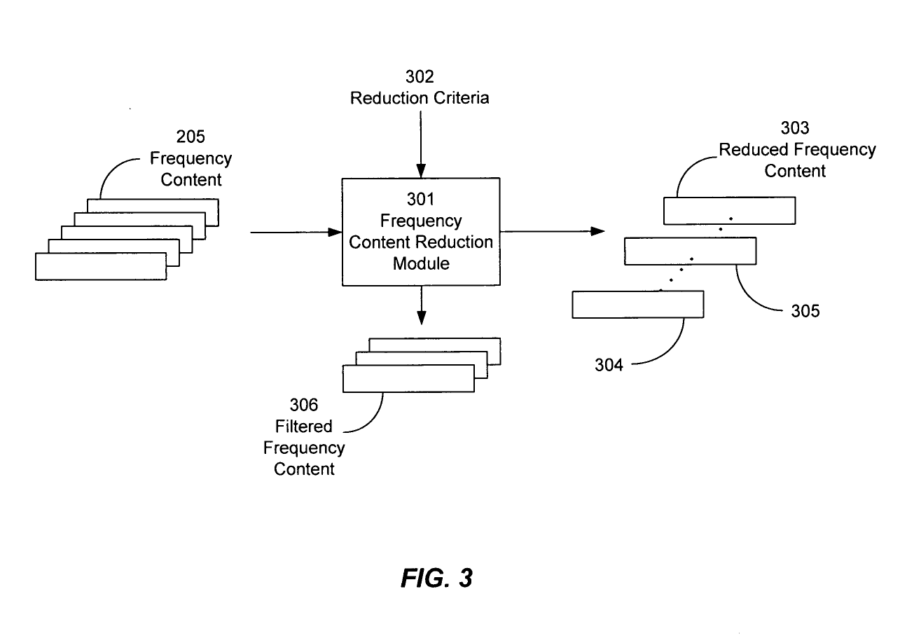

Proceeding to 1105 of FIG. 11 and referring to FIG. 3, the frequency content reduction module 301 reduces the frequency content 205 to a smaller set of data (the reduced frequency content 303). In one embodiment, the frequency content reduction module 301 removes some of the blocks 206, 207 from the frequency content 205, leaving the blocks 304, 305 in the reduced frequency content 303. The removed blocks are illustrated in FIG. 3 as filtered frequency content 306. In order to determine what blocks are to be removed from the frequency content 205, the frequency content reduction module 301 relies on reduction criteria 302. The criteria 302 includes, but are not limited to, what sounds signified by the frequency content are not noticeable or have little quality effect to a listener if the input file 101 would be played without the sounds. Determining what sounds are less significant is quantified by measurable statistics in order for the frequency content reduction module 301 to be able to use the criteria 302. The statistics to define the reduction criteria 302 may be predefined for all audios or variable depending on the type of audio being converted (e.g., one set of criteria for classical music and one set of criteria for pop rock). Metrics and algorithms to reduce the frequency content include, but are not limited to: Principal Component Analysis (PCA; discrete Karhunen-Loeve transform); K-means algorithm (or any similar clustering algorithm); vector sorting algorithms; and eigenvector analysis and reduction.

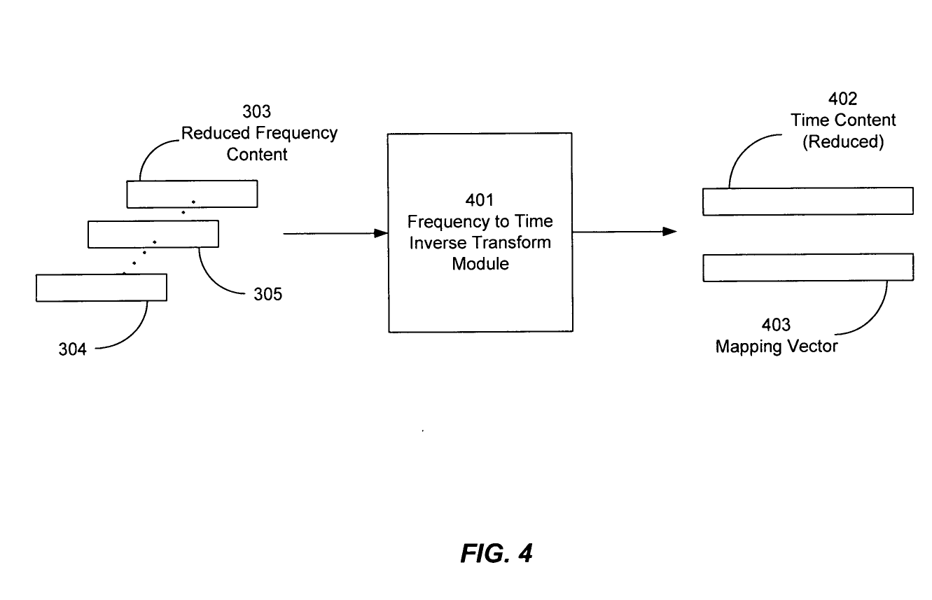

Once the frequency content 205 is filtered to create reduced frequency content 303 (FIG. 3), the frequency to time inverse transform module 401 in FIG. 4 converts the reduced frequency content 303 from frequency domain into time domain (1106 of FIG. 11). Therefore, the blocks 304, 305 of the reduced frequency content 303 are converted and combined into a time information of sounds (time content 402). The sounds, being a portion of higher frequency content of the input file to a listener would be the short or abrupt sounds of an audio. For example, in a jazz song, the sounds may include muted cymbal taps and various other percussion sounds. In transforming the reduced frequency content 303 into time domain, the frequency to time inverse transform module 401 also creates a mapping vector 403 to map exactly where each sound in the time content 402 is to be played in track 1 104 if track 1 is played.

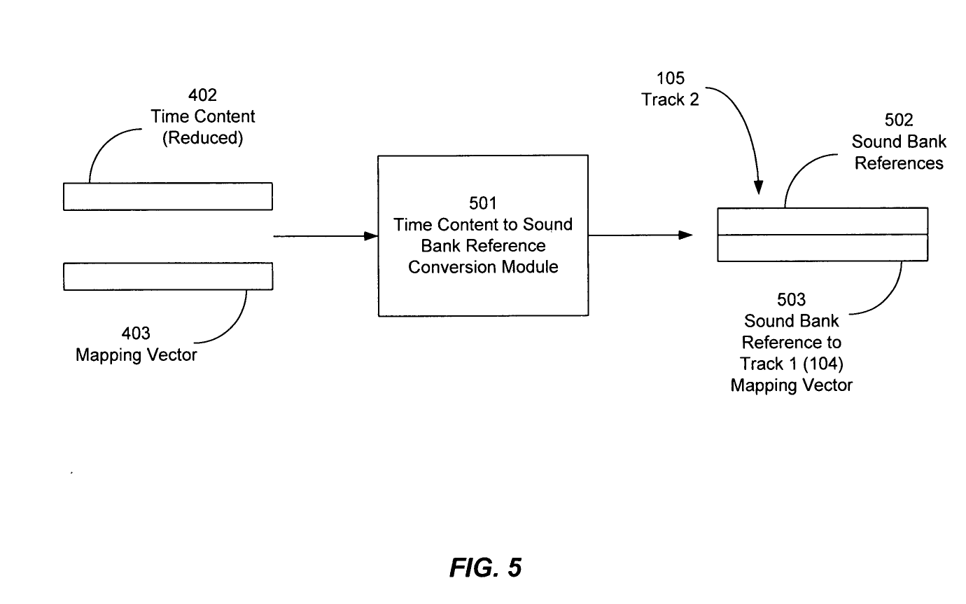

Referring to FIG. 5, module 501 determines a reference to a bank of sounds (a sound bank stored on the device to play the file) that mimics a sound of the reduced time content 402 in 1107 of FIG. 11. For example, a cymbal tap of a jazz song may be mimicked by one generic sound in the sound bank. In one embodiment, the module 501 can combine multiple sounds in the sound bank to more closely mimic the sound of the reduced time content 402. Therefore, the module 501 would determine multiple sound references to the sound bank for each sound to be mimicked. In one embodiment, the sound bank reference is an index of a buffer storing small audio clips.

For the sound to be mimicked, the module 501 also determines its position/location at where it is to be played during play of Track 1 104 (1108 of FIG. 11). For example, if the cymbal tap occurs at time 51.28 seconds of a song, the module 501 maps the sound bank references to mimic the sound to location corresponding to 51.28 seconds into Track 1 104. The module may also map the sound bank references to a predetermined time ahead of where the sound is to be mimicked. Therefore, the device has enough time to fetch the sounds from the sound bank in order to mimic the sound in time with play of Track 1 104. The module 501 uses the mapping vector 403 in mapping the sound bank reference to a position of Track 1 104. Once the module 501 maps the sound bank reference to Track 1 104 in 1108, the module 501 determines if more sounds need to be mimicked and referenced to Track 1 104 (1109 in FIG. 11).

If another sound to mimic and reference exists in the reduced time frequency content 402, process flows to 1110 and 1111 in FIG. 11, where the module 501 determines sound bank reference(s) (1110) and maps the sound bank reference(s) to a position of Track 1 104 (1111) for the next sound of the reduced time frequency content 402 to be mimicked. Process then reverts to decision 1109, where module 501 again determines whether another sound to be mimicked exists. Once no other sounds to be mimicked exist in the reduced time frequency content 402, process flows to 1112. Module 501 (FIG. 5) thus stores all of the determined sound bank references 502 with the mapping vector 503 containing the mapping of each sound bank reference or sound to be mimicked to a position of Track 1 104. The mapping vector 503 and the sound bank references 502 may be stored together to create Track 2 105 (1112 of FIG. 11). The gain for each of the sound bank references (stored sounds) may also be stored in Track 2 105 in order to determine volume of playback with respect to the volume of playback of Track 1 104.

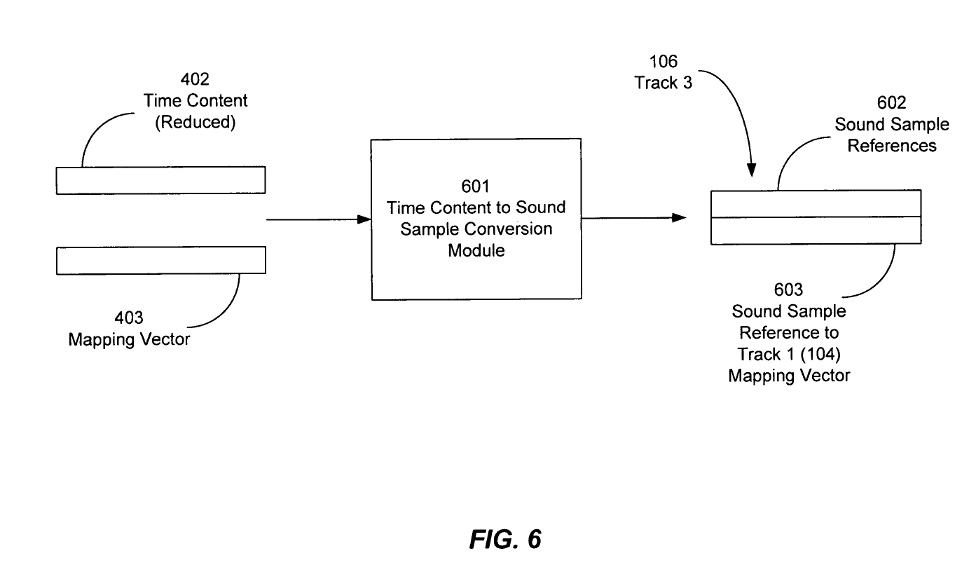

Module 501 (FIG. 5) may not be able to correctly mimic some sounds of the reduced time frequency content 402. One reason for this is that none of the sounds in the sound bank may close enough resemble the sound to be mimicked. Therefore, the file conversion system 102 determines if any sounds of the reduced time time content 402 were not referenced to the sound bank and mapped to Track 1 (1113 of FIG. 11). In one embodiment, the module 501 determines whether a sound in the reduced content 402 is unable to be mimicked. The module 501 may then mark the sound in the reduced time content 402 to signify that the sound cannot be mimicked. In another embodiment, referring to FIG. 6, the module 601 determines if any sounds exist that could not be mimicked by the sound bank.

If no such sounds exist, then process flows to and skips 1116 and track 3 106 is not created since track 3 106 is not necessary because no other sounds need to be recreated. Alternatively, track 3 106 may be saved by the module 601 (FIG. 6) as null data or a sound sample reference 602 and a mapping vector 603 with no data and/or zeros.

If a sound that cannot be correctly mimicked by sounds in the sound bank exist, process flows to 1114 (FIG. 11). In 1114, the module 601 will create a sound and/or convert the sound in the reduced time content 402 to a sound sample. In one embodiment, the sound sample may be, but is not limited to, a small PCM audio file and/or a wave file of the sound. The module 601 then maps the sound sample to the location in the Track 1 104 where the sound is to be played (1115 in FIG. 11). The mapping is stored in the mapping vector 603.

The module 601 may also map the sound sample to a predetermined time ahead of where the sound is to be played. Therefore, the device has enough time to fetch the sound sample from memory in order to mimic the sound in time with play of Track 1 104. The module 601 uses the mapping vector 403 in mapping the sound bank reference to a position of Track 1 104. Once the module 601 maps the sound sample to Track 1 104 in 1115, the module 601 determines if more sounds need to be created and referenced to Track 1 104 (1113 in FIG. 11). 1113-1115 repeat until all sounds to be created have been created and referenced to Track 1 104.

When the file conversion system 102 determines that no other sounds are to be created (and at least one sound has been created), process flows to 1116. In 1116, the created sounds (sound samples) are all stored in sound sample references 602 and the mappings to each of the sound samples are stored in mapping vector 603. The sound sample references 602 and mapping vector 603 are stored together to create Track 3 106. The gain for each of the sound sample references (created sounds) may also be stored in Track 3 106 in order to determine volume of playback with respect to the volume of playback of Track 1 104.

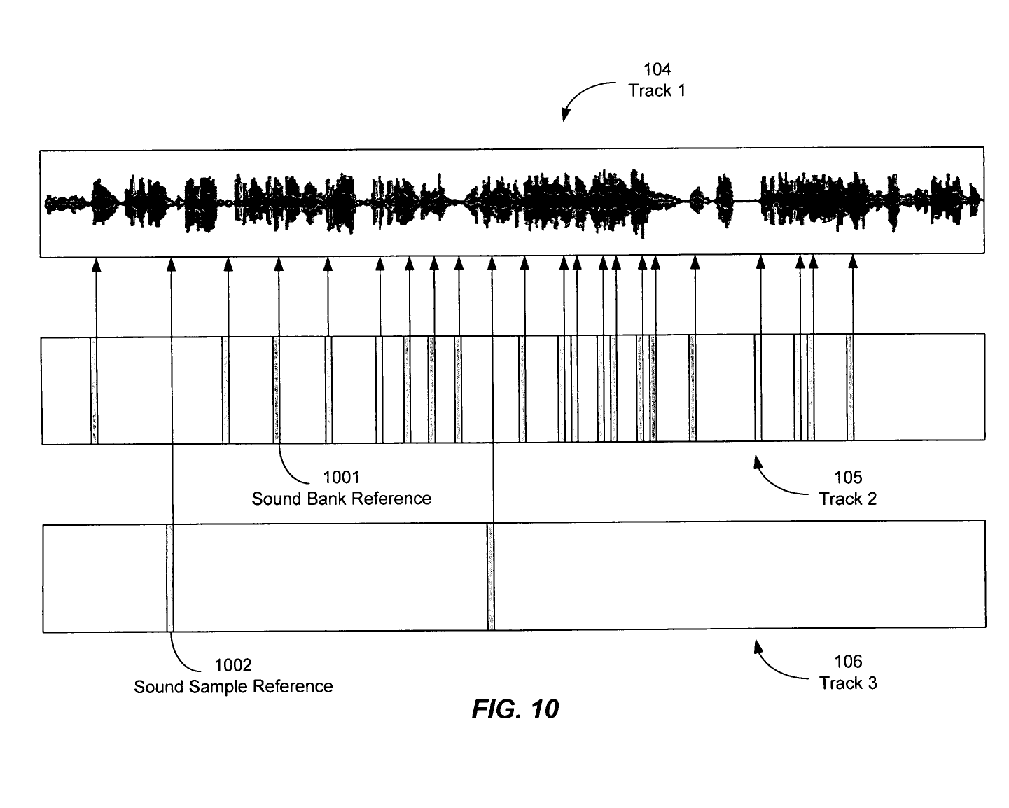

FIG. 10 illustrates an example mapping of the references in Tracks 2 and 3 (105, 106) to Track 1 104 of the output file 103 (multi-track file). Track 1 104 is an audio track to be played. The sound bank references 1001 of Track 2 105 and the sound samples 1002 of Track 3 106 are referenced to their respective locations in Track 1 104. The mapping may also include the gain for each of the sound bank references 1001 and sound samples 1002 in order to determine the volume of playback of each of the sound bank references 1001 and/or sound samples 1002 with respect to the volume of playback of Track 1 104.

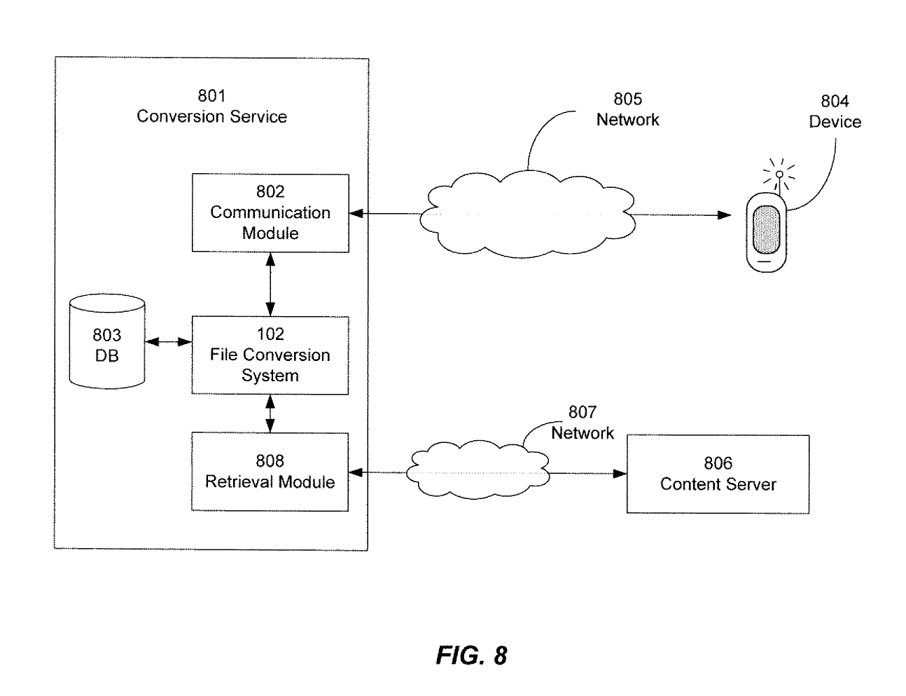

FIG. 8 illustrates an example service, network, and device for creating, distributing, and playing the output file 103. The conversion service 103 includes the file conversion system 102. The conversion service also generally includes a communication module 802, a database (storage) 803, and a retrieval module 804. The file conversion system 102 of the conversion service is able to communicate with a device 804 via the communication module 802 through a network 805. Exemplary networks include, but are not limited to CDMA, TDMA, GSM, and Edge networks. The device 804 is to receive, optionally store, and play the output file 103. Exemplary devices 804 include cellular telephones and personal digital assistants (PDA's). The output file 103 may be used as a notification or ringtone.

The input file 101 needed by the file conversion system 102 to create the output file 103 is either stored on the conversion service 801 (e.g., in DB 803) or is retrieved from a content server 806 via the network 807. In one embodiment, the content server 806 is a proprietary server for the conversion service 801 storing a multitude of audio tracks to be converted when asked for by a user of the device 804. The content server and/or the conversion service 801 may also include inputs (such as optical drives) to read music or other audio for conversion. In another embodiment, the content server 806 is a music download site, such as Itunes® IStore®, Sony Sonicstage® store, Napster®, etc. connected to by the conversion service 801 via the internet. Before conversion, the input file 101 may be retrieved and then stored in DB 803.

Referring to FIG. 9, an example of a device 804 for play of an output file 103 generally includes a memory 901, file execution module 903, sound bank 904, and output module 905. The device 804 receives the output file 103 from the conversion service 801. The device 804 then stores the output file 103 in memory 901. In another embodiment, the output file 103 is streamed to the device 804 when it is to be played so that less memory is consumed for playing the output file 103. The output module 905 includes a speaker and/or a line out for headphones or speaker for listening to the output file 103. The file execution module may be a processor (e.g., CPU) or software executed by a processor to play the output file 103. The sound bank 904 is a bank of locations to store a sound per location. For example, a wave or PCM audio sample (sounds 1-N) are each stored in a location of the sound bank. One hardware implementation of the sound bank 904 is a cache, a dynamic memory such as RAM where the sounds are loaded from a memory during device 804 startup, a ROM, and/or a flash memory.

One exemplary embodiment of the process for playing the output file 103 includes:
Arm (Load and prepare to play) Track 1 104 to start play;
Load and pre-parse Track 2 105;
Load and pre-parse Track 3 106 (if necessary); and
Fire (begin play of) all tracks simultaneously.

In another embodiment for playing the output file 103, the output file 103 is streamed from memory 901 with pointers from tracks 2 and 3 being used to determine when to arm and play the sound bank references (track 2) or the created sound (track 3) as needed and at what volume with respect to the volume of play of Track 1 104. Thus, less memory (e.g., RAM) is required in playback of the output file 103.

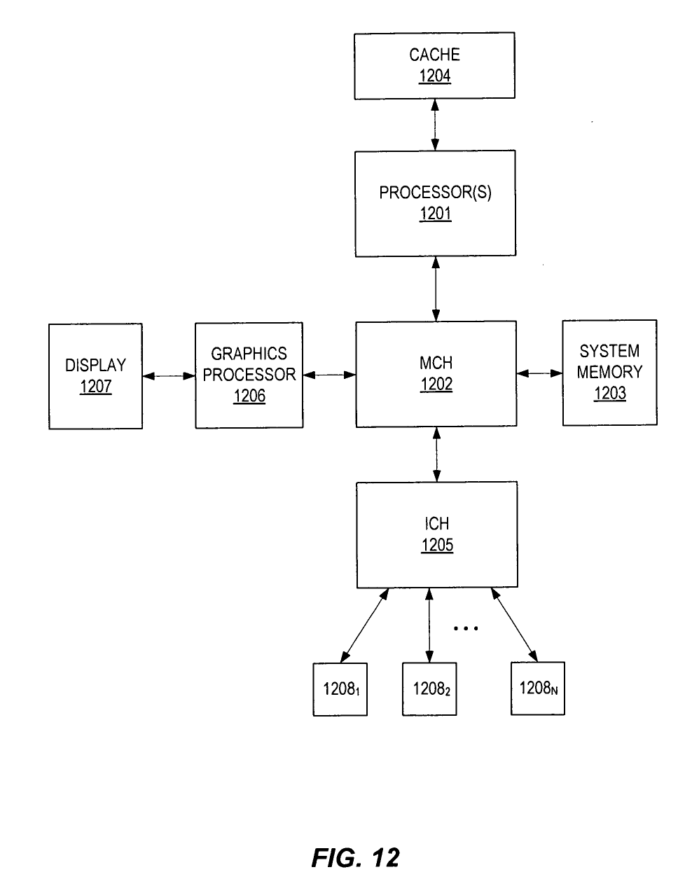

FIG. 12 shows an embodiment of a computing system (e.g., a computer). The exemplary computing system of FIG. 12 includes: 1) one or more processors 1201; 2) a memory control hub (MCH) 1202; 3) a system memory 1203 (of which different types exist such as DDR RAM, EDO RAM, etc,); 4) a cache 1204; 5) an I/O control hub (ICH) 1205; 6) a graphics processor 1206; 7) a display/screen 1207 (of which different types exist such as Cathode Ray Tube (CRT), Thin Film Transistor (TFT), Liquid Crystal Display (LCD), DPL, etc.; and/or 8) one or more I/O devices 1208.

The one or more processors 1201 execute instructions in order to perform whatever software routines the computing system implements. The instructions frequently involve some sort of operation performed upon data. Both data and instructions are stored in system memory 1203 and cache 1204. Cache 1204 is typically designed to have shorter latency times than system memory 1203. For example, cache 1204 might be integrated onto the same silicon chip(s) as the processor(s) and/or constructed with faster SRAM cells whilst system memory 1203 might be constructed with slower DRAM cells. By tending to store more frequently used instructions and data in the cache 1204 as opposed to the system memory 1203, the overall performance efficiency of the computing system improves.

System memory 1203 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 1203 prior to their being operated upon by the one or more processor(s) 1201 in the implementation of a software program. Similarly, data that a software program determines should be sent from the computing system to an outside entity through one of the computing system interfaces, or stored into an internal storage element, is often temporarily queued in system memory 1203 prior to its being transmitted or stored.

The ICH 1205 is responsible for ensuring that such data is properly passed between the system memory 1203 and its appropriate corresponding computing system interface (and internal storage device if the computing system is so designed). The MCH 1202 is responsible for managing the various contending requests for system memory 1203 access amongst the processor(s) 1201, interfaces and internal storage elements that may proximately arise in time with respect to one another.

One or more I/O devices 1208 are also implemented in a typical computing system. I/O devices generally are responsible for transferring data to and/or from the computing system (e.g., a networking adapter); or, for large scale non-volatile storage within the computing system (e.g., hard disk drive). ICH 1205 has bi-directional point-to-point links between itself and the observed I/O devices 1208.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, flash, magnetic or optical cards, propagation media or other type of media/machine-readable medium suitable for storing electronic instructions.

For example, in another embodiment of the present invention, the decoder module 202 is able to decode inputs other than a file (e.g., streaming audio, multiple files that together create one audio program). Furthermore, the decoder module 202 is able to decode inputs other than audio, such as video. In another embodiment as a further example, the decoded audio from input file decoder module 202 is converted to frequency domain by the time to frequency transform module 204 before being filtered by the filter bank module 203.

In another example, the file conversion system is able to process and/or create a multitude of audio formats including, but not limited to, Advanced Audio Encoding (AAC), High Efficiency Advanced Audio Encoding (HE-AAC), Advanced Audio Encoding Plus (AACPlus), MPEG Audio Layer-3 (MP3), MPEG Audio Layer-4 (MP4), Adaptive Transform Acoustic Coding (ATRAC), Adaptive Transform Acoustic Coding 3 (ATRAC3), Adaptive Transform Acoustic Coding 3 Plus (ATRAC3Plus), Windows Media Audio (WMA), PCM audio, and/or any other currently existing audio format. In addition, for some files, a group of special sounds to be stored in a subset of locations in the sound bank is transferred with the file and stored in the sound bank for correct playback of the file on the device. Furthermore, Track 3 is not essential for playback of the file and therefore is not necessary to create by the file conversion system 102. Additionally, the multi-track file (output file 103) may be similar to an XMF file.

Furthermore, the triggering of sound samples and sound bank references for tracks 2 and 3 has been generally illustrated. Triggering of sound references may be done nonuniformly in time (e.g., as needed for playback with Track 1). Alternatively, the sound samples and sound bank references may be triggered uniformly at specific time steps throughout playback of the output file 103. For example in a specific implementation, 128 samples make a frame and sound bank references and sound samples may be armed and fired every frame (128 samples).

In an example service 801, the service 801 may include a pay-per-output file system or pay-per-use system where the user and/or device 804 is queried for payment before sending the output file 103 to the device 804. The user may also connect to and pay the conversion service through a computer via the internet or a PSTN where the user is asked for an account number or credit card or check number.

The modules of the file conversion system 102 and the conversion service 801 may include software, hardware, firmware, or any combination thereof. For example, the modules may be software programs available to the public or special or general purpose processors running proprietary or public software. The software may also be specialized programs written specifically for the file conversion process.

Accordingly, the scope and spirit of the invention should be judged in terms of the claims which follow.

What is claimed is:

1. A method for converting an audio data, comprising:
separating the audio data into a first set of data and a second set of data;
converting the first set of data into a track of the audio data;
converting the second set of data into an at least one reference to a stored sound; and
mapping the at least one reference to the stored sound to an at least one position in the track where the stored sound is to be played when the track is played.

2. The method of claim 1, further comprising:
converting the second set of data into an at least one created sound and a reference to each created sound; and
mapping the at least one reference to the created sound to an at least one position in the track where the created sound is to be played when the track is played.

3. The method of claim 1, wherein separating the audio data into the first set of data and the second set of data includes:
filtering the audio, wherein the first set of data is filtered low frequency data and further wherein the second set of data is filtered high frequency data.

4. The method of claim 1, wherein converting the second set of data into the at least one reference to the stored sound includes reducing the amount of data in the second set of data.

5. The method of claim 1, wherein the stored sound is a sound in wave and/or a PCM audio format previously stored on devices to play the audio data.

6. The method of claim 2, wherein the created sound is in a wave and/or a PCM audio format.

7. The method of claim 1, wherein the audio data to be converted is in a format of one of the group consisting of:
Advanced Audio Encoding (AAC);
High Efficiency Advanced Audio Encoding (HE-AAC);
Advanced Audio Encoding Plus (AACPlus);
MPEG Audio Layer-3 (MP3);
MPEG Audio Layer-4 (MP4);
Adaptive Transform Acoustic Coding (ATRAC);
Adaptive Transform Acoustic Coding 3 (ATRAC3);
Adaptive Transform Acoustic Coding 3 Plus (ATRAC3Plus); and
Windows Media Audio (WMA).

8. The method of claim 7, further comprising decoding the audio data into a raw format.

9. The method of claim 1, wherein the track is encoded in a format of one of the group consisting of:
Advanced Audio Encoding (AAC);
High Efficiency Advanced Audio Encoding (HE-AAC);
Advanced Audio Encoding Plus (AACPlus);
MPEG Audio Layer-3 (MP3);
MPEG Audio Layer-4 (MP4);
Adaptive Transform Acoustic Coding (ATRAC);
Adaptive Transform Acoustic Coding 3 (ATRAC3);
Adaptive Transform Acoustic Coding 3 Plus (ATRAC3Plus); and
Windows Media Audio (WMA).

10. The method of claim 1, further comprising mapping each reference to the stored sound to a value to determine the volume the stored sound is to be played relative to the volume the track is played.

11. A system for converting an audio data, comprising:
a module to separate the audio data into a first set of data and a second set of data;
a module to convert the first set of data into a track of the audio data;
a module to convert the second set of data into an at least one reference to a stored sound; and
a module to map the at least one reference to the stored sound to a position in the track where the stored sound is to be played when the track is played.

12. The system of claim 11, further comprising:
a module to convert the second set of data into an at least one created sound and a reference to each created sound; and
a module to map the at least one reference to the created sound to an at least one position in the track where the created sound is to be played when the track is played.

13. The system of claim 11, wherein the module to separate the audio data into the first set of data and the second set of data includes:
an at least one filter to filter the audio, wherein the first set of data is filtered low frequency data and further wherein the second set of data is filtered high frequency data.

14. The system of claim 11, wherein the module to convert the second set of data into the at least one reference to the stored sound includes reducing the amount of data in the second set of data.

15. The system of claim 11, wherein the stored sound is a sound in a wave and/or a PCM audio format previously stored on devices to play the audio data.

16. The system of claim 12, wherein the created sound is in a wave and/or a PCM audio format.

17. The system of claim 11, wherein the audio data to be converted is in a format of one of the group consisting of:
Advanced Audio Encoding (AAC);
High Efficiency Advanced Audio Encoding (HE-AAC);
Advanced Audio Encoding Plus (AACPlus);
MPEG Audio Layer-3 (MP3);
MPEG Audio Layer-4 (MP4);
Adaptive Transform Acoustic Coding (ATRAC);
Adaptive Transform Acoustic Coding 3 (ATRAC3);
Adaptive Transform Acoustic Coding 3 Plus (ATRAC3Plus); and
Windows Media Audio (WMA).

18. The system of claim 17, further comprising a module to decode the audio data into a raw format.

19. The system of claim 11, wherein the track is encoded in a format of one of the group consisting of:
Advanced Audio Encoding (AAC);
High Efficiency Advanced Audio Encoding (HE-AAC);
Advanced Audio Encoding Plus (AACPlus);
MPEG Audio Layer-3 (MP3);
MPEG Audio Layer-4 (MP4);
Adaptive Transform Acoustic Coding (ATRAC);
Adaptive Transform Acoustic Coding 3 (ATRAC3);
Adaptive Transform Acoustic Coding 3 Plus (ATRAC3Plus); and
Windows Media Audio (WMA).

20. The system of claim 11, further comprising a module to map each reference to the stored sound to a value to determine the volume the stored sound is to be played relative to the volume the track is played.

21. A system for converting an audio data, comprising:
means for separating the audio data into a first set of data and a second set of data;
means for converting the first set of data into a track of the audio data;
means for converting the second set of data into an at least one reference to a stored sound; and
means for mapping the at least one reference to the stored sound to a position in the track where the stored sound is to be played when the track is played.

22. The system of claim 21, further comprising:
means for converting the second set of data into an at least one created sound and a reference to each created sound; and
means for mapping the at least one reference to the created sound to an at least one position in the track where the created sound is to be played when the track is played.

23. An apparatus for playing an audio data, comprising:
a memory to store:
a track,
an at least one reference to an at least one stored sound, and
a mapping of the at least one reference to the stored sound to an at least one position in the track where the at least one stored sound is to be played when the track is played; and
a processor to play:
the track, and
the at least one stored sound in parallel to the track being played at an at least one position in the track according to the mapping of the at least one reference to the stored sound.

24. The apparatus of claim 23, wherein:
the memory to store:
an at least one created sound and a reference to each created sound, and
a mapping of the at least one reference to the created sound to an at least one position in the track where the created sound is to be played when the track is played; and
the processor to play:
the at least one created sound in parallel to the track being played at an at least one position in the track according to the mapping of the at least one reference to the created sound.

25. The apparatus of claim 23, further comprising a sound bank from where the at least one stored sound is retrieved before the at least one stored sound is to be played.

26. The apparatus of claim 25, wherein the sound bank is a table of preexisting sounds.

27. The apparatus of claim 26, wherein the at least one stored sound is in a wave and/or a PCM audio format.

28. The apparatus of claim 23, wherein the track is encoded in a format of one of the group consisting of:
Advanced Audio Encoding (AAC);
High Efficiency Advanced Audio Encoding (HE-AAC);
Advanced Audio Encoding Plus (AACPlus);
MPEG Audio Layer-3 (MP3);
MPEG Audio Layer-4 (MP4);
Adaptive Transform Acoustic Coding (ATRAC);
Adaptive Transform Acoustic Coding 3 (ATRAC3);
Adaptive Transform Acoustic Coding 3 Plus (ATRAC3Plus); and
Windows Media Audio (WMA).

29. The apparatus of claim 23, wherein the track is low frequency content of the audio data and the at least one stored sound is high frequency content of the audio data.

30. The apparatus of claim 23, wherein the mapping includes a value for each reference to the stored sound to determine the volume the stored sound is to be played relative to the volume the track is played.

31. A method for playing an audio data, comprising:
playing a track of the audio data; and
playing an at least one stored sound in parallel to the track being played at an at least one position in the track according to a mapping of a reference to the at least one stored sound to the at least one position in the track.

32. The method of claim 31, further comprising:
playing an at least one created sound in parallel to the track being played at an at least one position in the track according to a mapping of a reference to the at least one created sound to the at least one position in the track.

33. The method of claim 31, wherein the track is low frequency content of the audio data and the at least one stored sound is high frequency content of the audio data.

34. The method of claim 31, further comprising:
retrieving the at least one stored sound from a sound bank before the at least one stored sound is to be played.

35. The method of claim 34, wherein the sound bank is a table of preexisting sounds.

36. The method of claim 34, wherein the at least one stored sound is in a wave and/or a PCM audio format.

37. The method of claim 31, wherein the track is encoded in a format of one of the group consisting of:
Advanced Audio Encoding (AAC);
High Efficiency Advanced Audio Encoding (HE-AAC);
Advanced Audio Encoding Plus (AACPlus);
MPEG Audio Layer-3 (MP3);
MPEG Audio Layer-4 (MP4);
Adaptive Transform Acoustic Coding (ATRAC);
Adaptive Transform Acoustic Coding 3 (ATRAC3);
Adaptive Transform Acoustic Coding 3 Plus (ATRAC3Plus); and
Windows Media Audio (WMA).

38. The method of claim 31, further comprising playing the at least one stored sound at a volume according to a value stored in the mapping of a reference to the at least one stored sound to the at least one position in the track, wherein the volume of play of the at least one stored sound is related to the volume of play of the track.
